(19) United States
(12) Patent Application Publication
(10) Pub. No.: US 2026/0277629 A1
(43) Pub. Date: Sep. 17, 2026

(54) CANONICAL FORMAT GENERATION FOR USER INTERFACE COMPONENTS

(71) Applicant: Salesforce, Inc., San Francisco, CA (US)

(72) Inventors: Prashanth Lakshmi Narayana Chaitanya Josyula, San Francisco, CA (US); Sridhar Subramaniam, Buffalo Grove, IL (US); Prakash Vadrevu, Hyderabad (IN); Akshay Patange, Hyderabad (IN)

(21) Appl. No.: 19/077,363

(22) Filed: Mar. 12, 2025

(51) Int. Cl. G06F 9/451; G06F 40/151

(52) U.S. Cl. CPC G06F 9/451; G06F 40/151

(57) ABSTRACT

Systems, devices, and techniques are disclosed for canonical format generation for user interface components. A block bundle including a schema definition that defines a structure and properties for a user interface component, editor configurations including specifications of customizations of the user interface component, renditions including renderer-specific implementations of the user interface component, and validation rules, may be received. A structure for a block tree may be generated from the schema definition. A block tree may be generated by performing transformations on the structure for the block tree using renderers and the renditions. The block tree may be validated based on the validation rules. The validated block tree may be used to generate the user interface component.

### BACKGROUND

Building user interfaces across different technologies may be difficult. Separate implementations of the same user interface components may be needed for different technologies such as HTML, Lightning Web Components (LWC), and React. This may result in the need to maintain multiple versions of the same user interface components that have been written specifically for implementation using different technologies. This redundancy increases both development time and costs and creates a risk of inconsistencies between implementations. Updates or changes to user interfaces components may need to be made to each version of a user interface component separately, resulting in potential discrepancies between the versions of the user interface component and increased maintenance overhead.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for canonical format generation for user interface components according to an implementation of the disclosed subject matter.

FIG. 2 shows an example arrangement suitable for canonical format generation for user interface components according to an implementation of the disclosed subject matter.

FIG. 3 shows an example arrangement suitable for canonical format generation for user interface components according to an implementation of the disclosed subject matter.

FIG. 4 shows an example arrangement suitable for canonical format generation for user interface components according to an implementation of the disclosed subject matter.

FIG. 5 shows an example arrangement suitable for canonical format generation for user interface components according to an implementation of the disclosed subject matter.

FIG. 6 shows an example arrangement suitable for canonical format generation for user interface components according to an implementation of the disclosed subject matter.

FIG. 7 shows an example procedure suitable for canonical format generation for user interface components according to an implementation of the disclosed subject matter.

FIG. 8 shows an example procedure suitable for canonical format generation for user interface components according to an implementation of the disclosed subject matter.

FIG. 9 shows an example procedure suitable for canonical format generation for user interface components according to an implementation of the disclosed subject matter.

FIG. 10 shows an example procedure suitable for canonical format generation for user interface components according to an implementation of the disclosed subject matter.

FIG. 11 shows a computer according to an implementation of the disclosed subject matter.

FIG. 12 shows a network configuration according to an implementation of the disclosed subject matter.

### DETAILED DESCRIPTION

Techniques disclosed herein enable canonical format generation for user interface components, which may allow for the generation of renderer-agnostic block trees that may be used to generate user interface components. A block bundle including a schema definition that defines a structure and properties for a user interface component, editor configurations including specifications of customizations of the user interface component, renditions including renderer-specific implementations of the user interface component, and validation rules, may be received. A structure for a block tree may be generated from the schema definition. A block tree may be generated by performing transformations on the structure for the block tree using renderers and the renditions. The block tree may be validated based on the validation rules. The validated block tree may be used to generate the user interface component.

A block bundle including a schema definition that defines a structure and properties for a user interface component, editor configurations including specifications of customizations of the user interface component, renditions including renderer-specific implementations of the user interface component, and validation rules, may be received. A schema for block bundles may be:

```
{
  title”: “Block Type Schema”,
  “type”: “object”,
  “properties”: {
    “id”: {
      “type”: “string”,
      “format”: “uuid”
    },
    “type”: {
      “type”: “string”
    },
    “definition”: {
      “title”: “Fully Qualified Name of a block type”,
      “type”: “string”
    },
    “children”: {
      “type”: “block-list-type”
    },
    “attributes”: {
      “type”: “object”
    }
  },
  “required”: [“definition”]
  }
```

The schema for block bundles may allow for the definition of a type of user interface component while maintaining type safety and validation rules. A block bundle may be a structured bundle that may include files of suitable types for storing the schema definition, editor configurations, renditions, and validation rules. The files may be, for example, JSON or HTML files. The schema definition of the block bundle may be a file that may define the structure and the properties of the user interface component. For example, a schema definition for a button may be:

```
{
  “type”: “object”,
  “title”: “Button Block”, “properties”: {
    “attributes”: {
      “type”: “object”,
      “properties”: {
        “text”: {
          “title”: “Button Text”,
          “type”: “text-type”
        },
        “uri”: {
          “title”: “Button URI”,
          “type”: “uri-type”
        },
        “width”: {
          “title”: “Button Width”,
          “type”: “integer-type”
        }
      },
      “required”: [“text”],
      “additionalProperties”: false
      }
  }
}
```

The editor configurations of the block bundle may be a file that may include specifications of customizations of the user interface component. For example, the editor configurations may include the properties of the user interface component that may appear in an editing window and may be adjusted when the user is being edited using a suitable editor interface. For example, an editor configuration for a button may be:

```
{
  editor”: {
  “componentOverrides”:
    { “text”: {
    “definition”: “namespace/inputText”
  },
  “uri”: {
    “definition”: “namespace/inputUrl”
  }
  },
  “layout”: {
    “definition”: “verticalLayout”,
    “children”: [
      {
      “definition”: “propertyLayout”,
      “attributes”: {
        “property”: “text”
        }
      },
      {
      “definition”: “propertyLayout”,
      “attributes”: {
        “property”: “uri”
        }
      }
      ]
    }
    }
  }
}
```

The renditions of the block bundle may be a file including renderer-specific implementations of the user interface component which may allow for the user interface component to be implemented using various different renderers. For example, an HTML specific renderer implementation of the button may be:

```
<div style=“{{~#if properties.width}}width:{{properties.width.value}}{{properties.widt
  <a href=“{{properties.uri}}” target=“_blank”>
    <span>{{~properties.text~}}</span>
  </a>
</div>
An LWC specific render implementation of the button may be:
{
definition”: “es-base-components/button”
}
```

The use of renditions in a block bundle may provide a standardized way for different rendering technologies to be used to implement the rendering of user interface components defined using the canonical format of the block bundle while maintaining consistent behavior and appearance in the implemented user interface components. A user interface component may have multiple renderer-specific implementations specified in the renditions of the block bundle for the user interface. Each render-specific implementation may adhere to the same base schema but may implement the user interface component using code specific to renderer of the render-specific implementation. The validation rules included in a block bundle may be rules that may ensure integrity of implementations of the user interface component generated from the block bundle. Block bundles may be renderer-agnostic, not tied to any single renderer technology, and may be infinitely nestable. Block bundles may be received from any suitable source.

A structure for a block tree may be generated from the schema definition. A compiler may receive a block bundle. The compiler may load the schema definition from the block bundle and parse block structures from the schema definition. The compiler may validate the syntax and semantics of the block structure. If the validation is successful, the compiler may load schema definitions for any child block bundles specified in the block bundle, process any dependencies for those child blocks, parse the schema definitions of the child blocks, and generate a structure for a block tree from the schema definitions of the block bundle and child blocks.

A block tree may be generated by performing transformations on the structure for the block tree using renderers and the renditions. The compiler may load the renderer-specific implementations from the renditions of the block bundle and use the renderers to apply renderer-specific transformations to the structure for the block tree, generating renderer-specific renditions for the block tree. The editor configurations may also be included in the block tree. The block tree, including the renderer-specific renditions, may be output by the compiler in any suitable file format.

The block tree may be validated based on the validation rules. The compiler may validate the output block tree using the validation rules from the block bundle. The compiler may parse the block tree and validate the basic structure of the block tree. The compiler may then validate the block tree against the schema definition and validate the implementation-specific renditions. If these validations are successful, the compiler may then perform the same validations on any child blocks in the block tree until a child block fails validation or all child blocks are successfully validated, resulting in the compiler performing validation on all of the child blocks in the block tree in a recursive manner if none of the child blocks fails validation. Once the block tree, and all of its child blocks, have been successfully validated, the final, optimized, validated block tree may be generated and output from the compiler. An example block tree may be:

```
{
  “type”: “block”,
  “definition”: “rootBlock”,
  “children”: [
    {
    “type”: “block”,
    “definition”: “section”,
    “children”: [
      {
      “type”: “block”,
      “definition”: “column”,
      “children”: [
        {
          “type”: “block”,
          “definition”: “heading”,
          “attributes”: {
            “level”: 3,
            “align”: “left”,
            “text”: “My Heading”
            }
        }
      ]
    }
  ]
},
{
  “type”: “block”,
  “definition”: “section”,
  “children”: [
    {
      “type”: “block”,
      “definition”: “column”,
      “children”: [
        {
          “type”: “block”,
          “definition”: “paragraph”,
          “attributes”: {
            “align”: “left”,
            “text”: “Sample content text...”
            }
          },
          {
          “type”: “block”,
          “definition”: “actionButton”,
          “attributes”: {
            “text”: “Click Me!”,
            “url”: “https://www.salesforce.com”
            }
          }
        ]
      }
  ]
},
{
  “type”: “block”,
  “definition”: “section”,
  “children”: [
    {
      “type”: “block”,
      “definition”: “column”,
      “children”: [
        {
          “type”: “block”,
          “definition”: “image”,
          “attributes”: {
            “imageFitConfig”: {
              “width”: {
              “value”: 100,
              “unit”: “%”
              }
            },
            “imageInfo”: {
              “url”: “https://salesforce.com/images/robot”,
            }
          }
        }
      ]
    }
  ]
},
{
  “type”: “block”,
  “definition”: “section”,
  “children”: [
    {
      “type”: “block”,
      “definition”: “column”,
      “children”: [
        {
          “type”: “block”,
          “definition”: “list”,
          “attributes”: {
            “content”: {
              “type”: “block”,
              “definition”: “listElement”,
              “attributes”: {
                “listStyle”: “unordered”
              },
              “children”: [
                {
                “type”: “block”,
                “definition”: “listItem”,
                “children”: [
                  {
                  “type”: “block”,
                  “definition”: “paragraph”,
                  “attributes”: {
                    “text”: “Action Item 1”
                  }
                }
              ]
            },
            {
              “type”: “block”,
              “definition”: “listItem”,
              “children”: [
                {
                “type”: “block”,
                “definition”: “paragraph”,
                “attributes”: {
                  “text”: “Action Item 2”
                }
              }
            ]
          }
        ]
      }
    }
  }
]
}
]
}
]
}
```

The validated block tree may be used to generate the user interface component. The validated block tree may be used as input to a renderer-agnostic canvas system. The renderer-agnostic canvas system may render the user interface component of the validated block tree according to any of the renderer-specific renditions in the validated block tree. For example, a user of the renderer-agnostic canvas system may select which of the renderer-specific renditions to use to render the user interface component. The editor configurations in the validated block tree may be used by the renderer-agnostic canvas system when the rendered user interface component is selected for editing, for example, allowing a user to change the various properties of the user interface component through a suitable editing window, or in any other suitable manner. The validated block tree may thus allow for the renderer-agnostic canvas system to render the user interface component of the validated block tree using any of the renderer-specific renditions while maintaining consistency in the appearance, behavior, and editable properties of the user interface component. This may allow, for example, for a user interface to be rendered for use in HTML, LWC, and React environments while maintaining consistency across the environments and without requiring that the user interface components of the user interface be written separately for each environment.

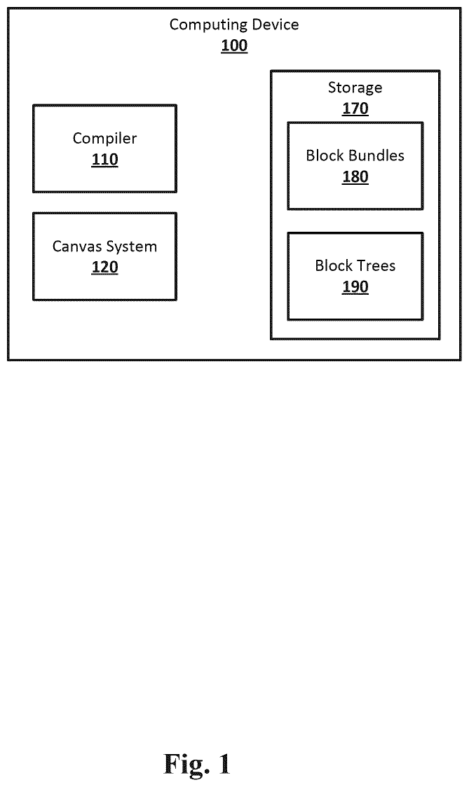

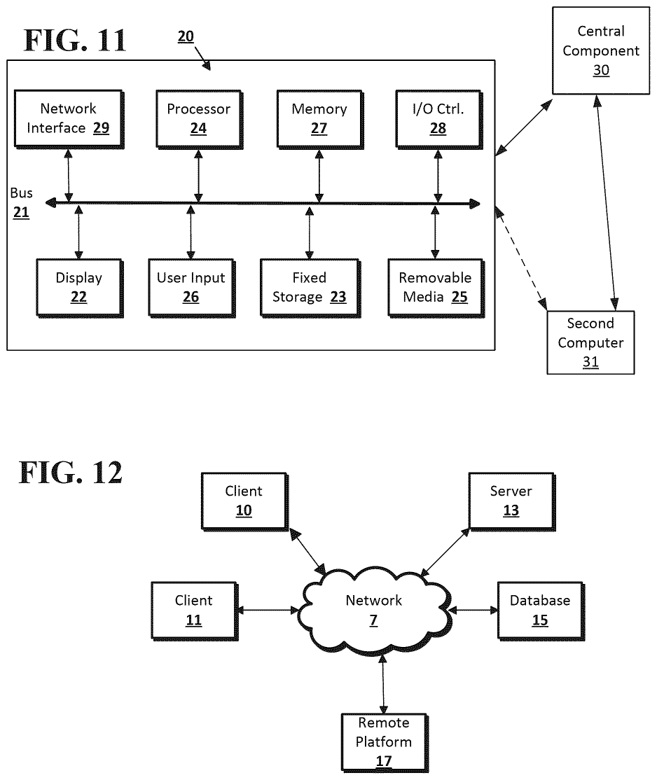

FIG. 1 shows an example system suitable for canonical format generation for user interface components according to an implementation of the disclosed subject matter. A computing device 100 may be any suitable computing device, such as, for example, a computer 20 as described in FIG. 11, or component thereof, for implementing canonical format generation for user interface components. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs). For example, the computing device 100 may be, or be part of, a cloud computing sever system that may be a multi-tenanted server system.

The computing device 100 may include a compiler 110. The compiler 110 may be any suitable combination of hardware and software of the computing device 100 for implementing a compiler for generating block trees from block bundles. The compiler 110 may be able to, for example, receive a block bundle, generate a structure for a block tree from the block bundle, generate a block tree from the structure for the block tree and from renderer-specific implementations in the block bundle, and validate and output the generated block tree. The compiler 110 may generate a block tree by compiling a block bundle in any suitable manner. For example, the compiler 110 may generate the structure for the block tree by loading the schema definition from the block bundle and parse block structures from the schema definition. The compiler 110 may validate the syntax and semantics of the block structure. If the validation is successful, the compiler 110 may load schema definitions for any child block bundles specified in the block bundle, process any dependencies for those child blocks, parse the schema definitions of the child blocks, and generate a structure for a block tree from the schema definitions of the block bundle and child blocks. The compiler 110 may perform transformations on the structure for the block tree using renderers and the renditions from the block bundle to generate a block tree. The compiler 110 may load the renderer-specific implementation from the renditions of the block bundle and use the renderers to apply renderer-specific transformations to the structure for the block tree, generating renderer-specific renditions for the block tree. The compiler 110 may also include the editor configurations in the block tree. The compiler 110 may, for example, validate the block tree based on the validation rules in the block bundle. The compiler 110 may parse the block tree and validate the basic structure of the block tree. The compiler 110 may then validate the block tree against the schema definition and validate the implementation-specific renditions. If these validations are successful, the compiler 110 may then perform the same validations on any child blocks in the block tree until a child block fails validation or all child blocks are successfully validated, resulting in the compiler 110 performing validation on all of the child blocks in the block tree in a recursive manner if none of the child blocks fails validation. Once the block tree, and all of its child blocks, have been successfully validated, the final, optimized, validated block tree may be generated and output from the compiler 110 and stored, for example, in storage 170 of the computing device 100.

The computing device 100 may include a canvas system 120. The canvas system 120 may be any suitable combination of hardware and software of the computing device 100 for editing user interfaces. The canvas system 120 may, for example, receive block trees as input. The canvas system 120 may provide a canvas that may be used to edit a user interface, including user interface components, as specified in the block tree input to the canvas system 120. The canvas system 120 may, for example, may allow for changes to properties of a user interface component from a block tree based on the editor configurations from the block tree. The canvas system 120 may be renderer agnostic and may allow for the generation of user interfaces with user interface components using any suitable renderers based on the renderer-specific implementations in the block bundles used to generate the block trees for the user interface components.

The storage 170 may be any suitable combination of hardware and software for storing data. The storage 170 may include any suitable combination of volatile and non-volatile storage hardware and may include components of the computing device 100 and hardware accessible to the computing device 100, for example, through wired and wireless direct or network connections. The storage 170 may store block bundles 180 and block trees 190. The block bundles 180 may be block bundles, each of which may include a schema definition that defines a structure and properties for a user interface component, editor configurations including specifications of customizations of the user interface component, renditions including renderer-specific implementations of the user interface component, and validation rules. The block tress 184 may be validated block trees generated and validated by the compiler 110 from the block bundles 180.

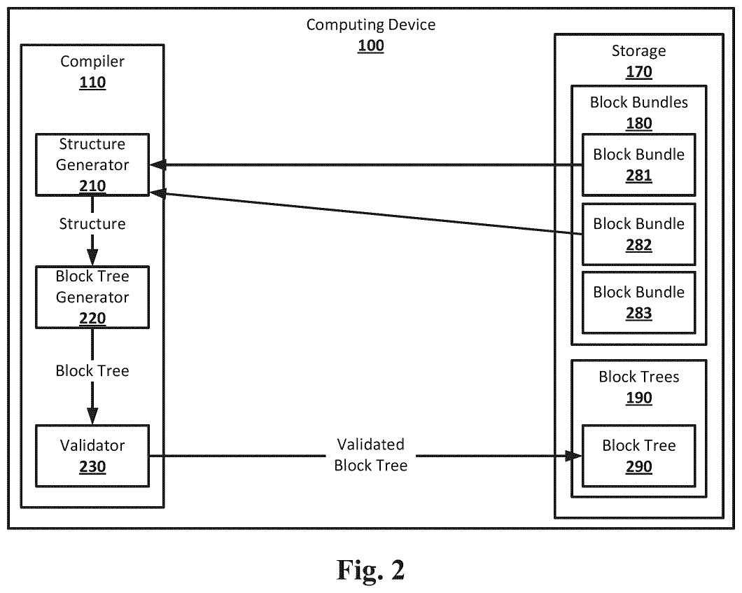

FIG. 2 shows an example arrangement suitable for canonical format generation for user interface components according to an implementation of the disclosed subject matter. The compiler 110 may receive a block bundle 210 from the storage 170. A structure generator 210 of the compiler 110 may generate a structure for a block tree from the block bundle 210. For example, the structure generator 210 may load block definitions from the block bundle 210, parse block structures from the block bundle 210, and validate the syntax and semantics of the block bundle 210. The structure generator 210 may then recursively generate block trees from any child blocks of the block bundle 210, such as, for example, the block bundle 282, and from any child blocks of those child blocks. The structure for the block tree for the block bundle 210 may then be generated from the block bundle 210 and the block trees generated from any child blocks of the block bundle 210.

The structure for the block tree may be output from the structure generator 210 to a block tree generator 220 of the compiler 110. The block tree generator 220 may generate a block tree for the block bundle 281 from the structure for the block tree by, for example, retrieving the renderer-specific implementations from the renditions of the block bundle 281 and applying renderer specific transformations to the structure for the block tree generated by the structure generator 210.

The block tree may be output from the block tree generator 220 to a validator 230 of the compiler 110. The validator 230 may generate a validated block tree from the block tree by, for example, parsing the block tree, validating the block structure of the block tree, validating the block tree against the schema definition from the block bundle 281, validating the renderer-specific renditions, and the recursively validating any child blocks, for example, from the block bundle 282, in the block tree. The validated block tree may be output from the compiler 110 and stored, for example, in the storage 170.

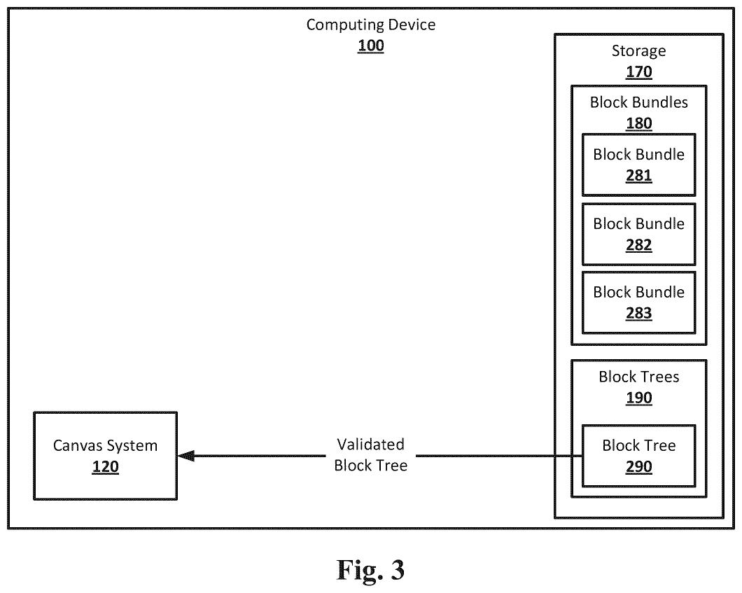

FIG. 3 shows an example arrangement suitable for canonical format generation for user interface components according to an implementation of the disclosed subject matter. The block tree 290 may be input to the canvas system 120. The canvas system 120 may canvas system 120 may render the user interface component of the validated block tree generated from the block bundle 281 according to any of the renderer-specific renditions in the validated block tree. For example, a user of the canvas system 120 may select which of the renderer-specific renditions to use to render the user interface component. The editor configurations in the validated block tree may be used by the canvas system 120 when the rendered user interface component is selected for editing, for example, allowing a user to change the various properties of the user interface component through a suitable editing window, or in any other suitable manner. The validated block tree may thus allow for the canvas system 120 to render the user interface component of the validated block tree using any of the renderer-specific implementations while maintaining consistency in the appearance, behavior, and editable properties of the user interface component.

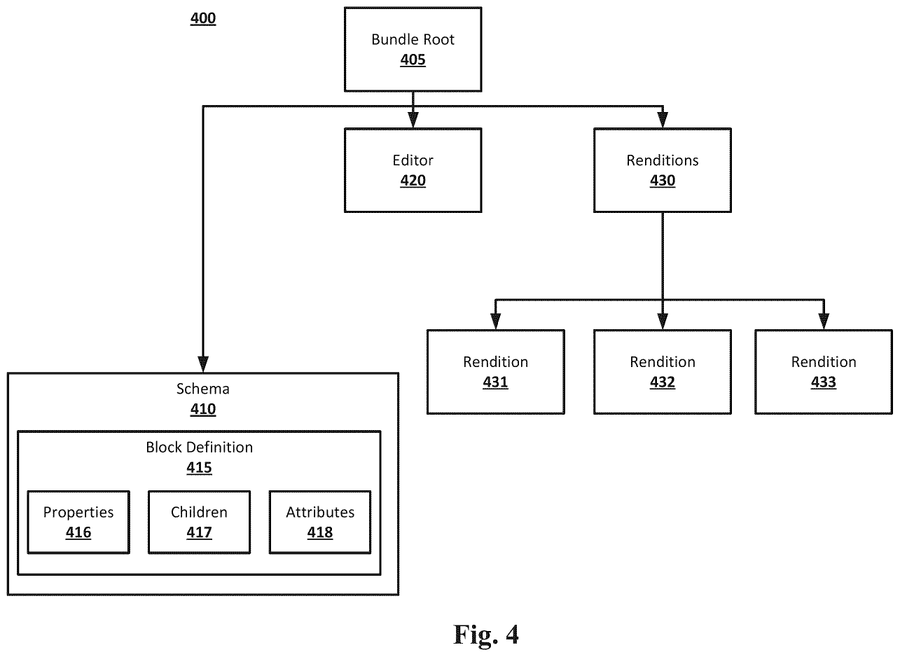

FIG. 4 shows an example arrangement suitable for canonical format generation for user interface components according to an implementation of the disclosed subject matter. A block bundle 400 for a user interface component may have a structure that may include a bundle root 405 that points to a schema 410, an editor 420, and renditions 430. The schema 410 may store the schema definition for the block bundle 400, for example, as block definition 415. The block definition 415 may include properties 416 and attributes 418 for the user interface component, along with children 417 which may be a listing of the child block bundles of the block bundle 400 that may be used in the generation of a block tree from the block bundle 400. The editor 420 may include the editor configurations for the block bundle 400. The renditions 430 may, for example, be a directory that may include files, such as rendition 431, rendition 432, and rendition 433, for the render-specific implementations for the block bundle 400. For example, the rendition 431 may be HTML specific, the rendition 432 may be LWC specific, and the rendition 433 may be React specific.

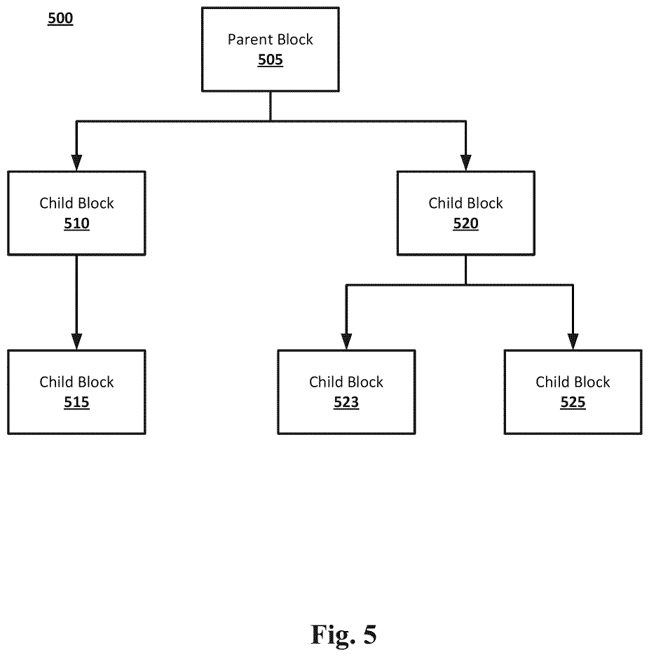

FIG. 5 shows an example arrangement suitable for canonical format generation for user interface components according to an implementation of the disclosed subject matter. A block tree 500 for a user interface component may have a structure that may include a bundle a parent block 505 any child blocks 510, 515, 523, and 525. The block tree 500 may be generated by the compiler 110 from, for example, the block bundle 400. The parent block 505 may be generated directly from the properties 416 and attributes 418 of the schema 410 and from the editor 420 and renditions 430. The child blocks 510, 515, 520, 523, and 525 may be, for example, the children 417, and may be generated from block bundles listed in the children 417 or from block bundles that are children of other block bundles. For example, the children 417 may list the block bundle that may be used to generate the child block 520, and that block bundle may list in its children the block bundles used to generate the child blocks 523 and 525, as child blocks may be infinitely nestable and compiled recursively.

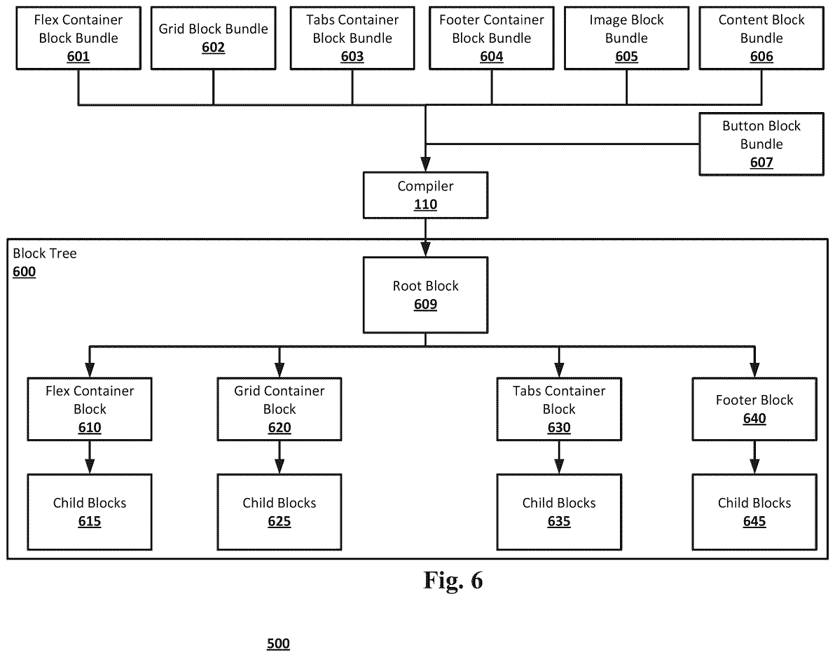

FIG. 6 shows an example arrangement suitable for canonical format generation for user interface components according to an implementation of the disclosed subject matter. A block tree 600, which may be, for example, a block tree for a web page, may be generated by the compiler 110 from flex container block bundle 601, grid block bundle 602, tabs container block bundle 603, footer container block bundle 604, image block bundle 605, content block bundle 606, and button block bundle 607. The block tree 600 may include a root block 609 that may connect to a flex container block 610, grid container block 620, tabs container block 630, and footer block 640. The flex container block 610 may have child blocks 615, which may include any number of child blocks nested to any suitable depth. For example, the child blocks 615 of the flex container block 610 may include a logo block that may include a logo image for the web page, a menu container block that may have menu link text child blocks that may include text and links for a web page menu, and a search block. The child blocks 625 of the grid container block 620 may include an image block and a content stack block that may include as child blocks a head block with text for a web page heading, a rich text block, and a button block. The child blocks 635 of the tabs container block 630, may include tab panel blocks which may have a child flex container block that may in turn have as child blocks a table component block and a rich text block. The child blocks 645 of the footer block 640 may include a grid container block that may indicate a grid with four columns and may have four child content stack blocks, one for each column, which may in turn have their own child blocks, such as a button block and input component block, for example, a button with the text “subscribe” and an input component that accepts an email address. The web page represented by the block tree 600 may be edited in the canvas system 120 and rendered using any suitable renderer from the renditions of the block bundles used to generate the block tree 600, allowing the web page to be edited in a renderer-agnostic manner and then implemented to be used with a suitable renderer, such as HTML, LWC, or React.

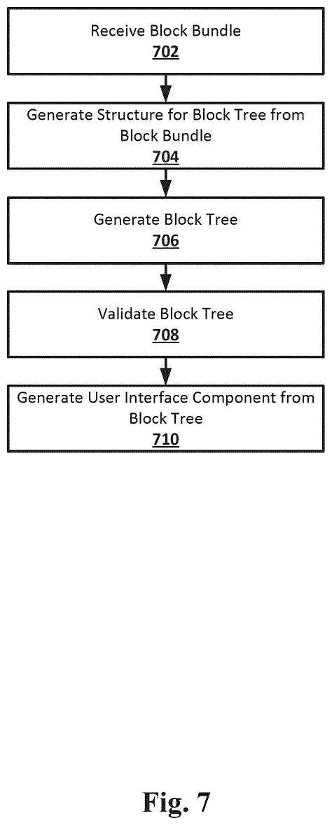

FIG. 7 shows an example procedure suitable for canonical format generation for user interface components according to an implementation of the disclosed subject matter. At 702, a block bundle may be received. For example, the block bundle 400 may be received at the compiler 110. The block bundle 400 may be a block bundle for a user interface component.

At 704, a structure for a block tree may be generated from the block bundle. For example, the compiler 110 may generate a structure for a block tree from the schema 410 of the block bundle 400, including generating block trees for any of the child blocks in the children 417.

At 706, a block tree may be generated. For example, the compiler 110 may apply render-specific transformations from renditions 431, 432, and 433 to the structure for a block tree generated from the block bundle 400 to generate the block tree 500. The compiler 110 may also use editor configurations from editor 420 in the generation of the block tree 500.

At 708, the block tree may be validated. For example, the compiler 110 may validate the block tree 500, including recursively validation the child blocks 510, 515, 520, 523, and 525. The compiler 110 may validate the block tree 500 according to any suitable validation rules that may be included in the block bundle 400. The block tree 500 may in a renderer-agnostic format.

At 710, a user interface component may be generated from the block tree. For example, the block tree 500 may be used with the canvas system 120 to generate the user interface component of the block bundle 400. The canvas system 120 may be used, for example, to edit the user interface component and to implement the user interface component using any suitable renderer.

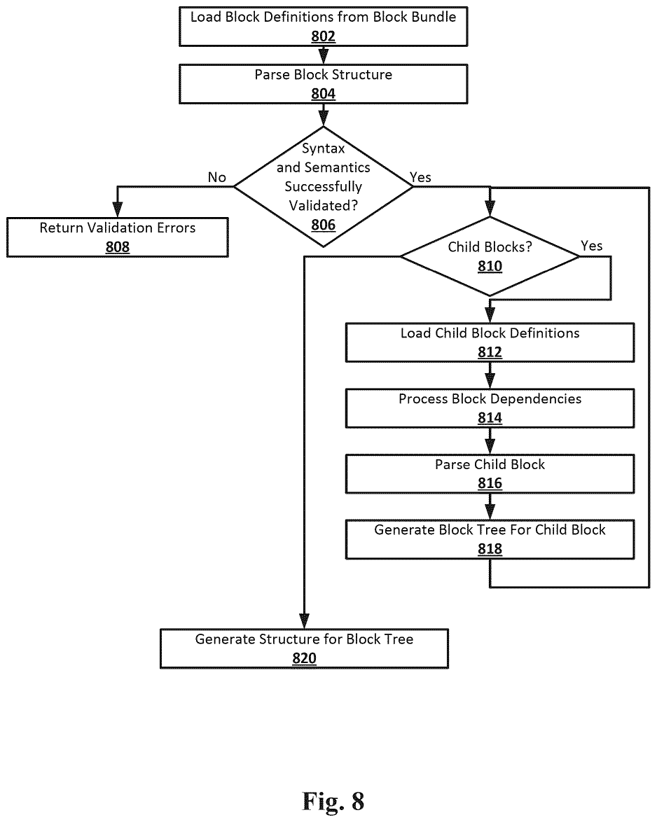

FIG. 8 shows an example procedure suitable for canonical format generation for user interface components according to an implementation of the disclosed subject matter. At 802, block definitions may be loaded from a block bundle. For example, the compiler 110 may load the block definition 415 from the block bundle 400.

At 804, a block structure may be parsed. For example, the compiler 110 may parse a block structure from the block bundle 400.

At 806, if the syntax and semantics of a block bundle are successfully validated, flow may proceed to 810. Otherwise, flow may proceed to 808. For example, the compiler 110 may attempt to validate the syntax and semantics of the block bundle 400.

At 808, validation errors may be returned. For example, the block bundle 400 may have failed validation by the compiler 110. The errors that resulted in the failed validation may be returned by the compiler 110.

At 810, if the block bundle includes any child blocks for which a block tree has not been generated flow may proceed to 812. Otherwise, flow may proceed to 820. For example, the block bundle 400 may indicate child blocks in the children 417. The indication of child blocks may point to other block bundles.

At 812, block definitions may be loaded from a child block bundle. For example, the compiler 110 may load the block definitions from the block bundle that is indicated in the children 417 of the block bundle 400.

At 814, block dependencies may be processed. For example, the compiler 110 may process any block dependencies of the block bundle specified as child of the block bundle 400.

At 816, the child block may be parsed. For example, the compiler 110 may parse the block bundle specified as child of the block bundle 400.

At 818, a block tree may be generated for the child block. For example, the compiler 100 may recursively generate a block tree, such as the child block 510, for the block bundle specified as child of the block bundle 400. This may include generating block trees for any children of the child block, and so to the bottom of the nesting of child blocks. For example, to generate the block tree of the child block 520, the compiler 110 may need to generate block trees of the child block 523 and child block 525 from block bundles indicated as children of the block bundle used to generate the block tree of the child block 520.

At 820, a structure for a block tree may be generated. For example, the compiler 110 may generate a structure for a block tree from the block bundle 400 from the schema 410 of the block bundle 400 and from block trees generated recursively starting with block bundles specified in the children 417, for example, the block trees for the child blocks 510, 515, 520, 523, and 525.

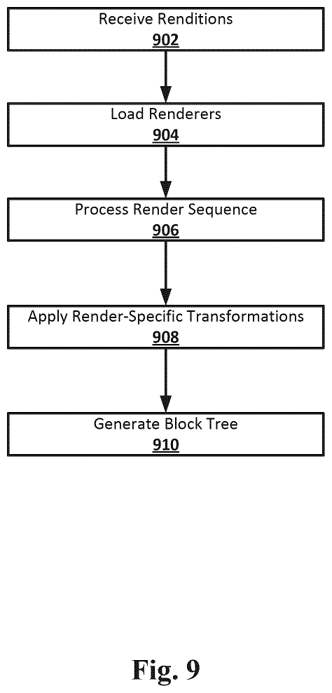

FIG. 9 shows an example procedure suitable for canonical format generation for user interface components according to an implementation of the disclosed subject matter. At 902, renditions may be received. For example, the compiler 110 may receive the renditions 430, including rendition 431, 432, and 433, from the block bundle 400.

At 904, renders may be loaded. For example, the compiler 110 may load the renderers, such as HTML, LWC, and React, for the render-specific implementations of the rendition 431, 432, and 433.

At 906, render sequences may be processed. For example, the compiler 110 may process render sequences for any of the renderers loaded for the render-specific implementations of the rendition 431, 432, and 433.

At 908, render-specific transformations may be applied. For example, the compiler 110 may use the loaded renderers to apply renderer-specific transformations to the structure for a block tree generated from the block bundle 400.

At 910, a block tree may be generated. For example, the compiler 110 may generate the block tree 500 from the structure for a block tree generated from the block bundle 400 that has had the renderer-specific transformations applied to it. This may result in the block tree 500 allowing for renderer-agnostic implementation, among the renderers for the render-specific implementations of the rendition 431, 432, and 433, of the user interface component of the block bundle 400.

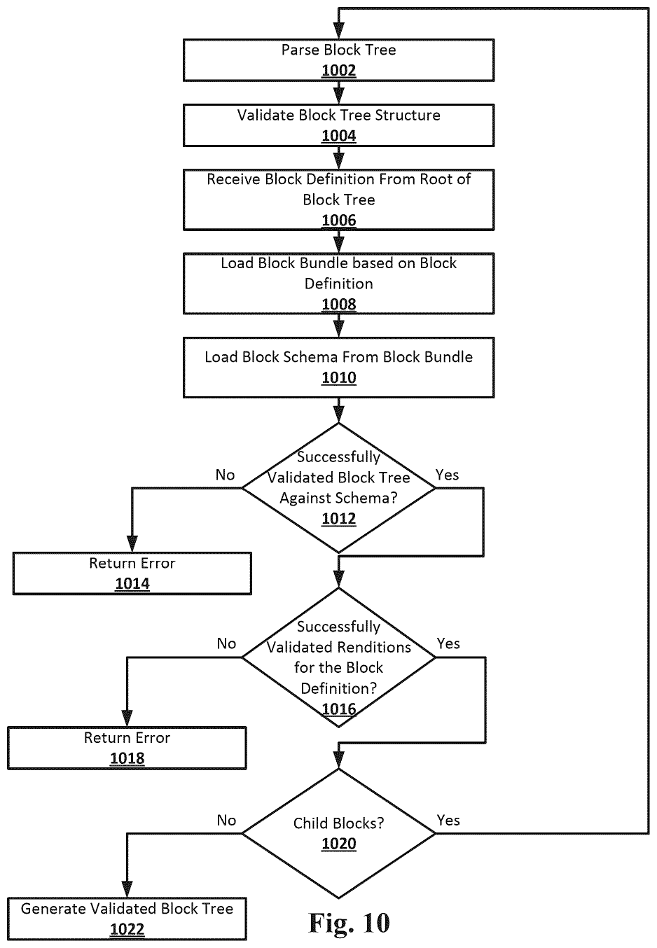

FIG. 10 shows an example procedure suitable for canonical format generation for user interface components according to an implementation of the disclosed subject matter. At 1002, a block tree may be parsed. For example, the compiler 110 may parse the block tree 500 to being validation of the block tree 500.

At 1004, the block tree structure may be validated. For example, the compiler 110 may validate the structure of the block tree 500.

At 1006, a block definition may be received from a root of the block tree. For example, the compiler 110 may receive a block definition, for example, the block definition 415, from the parent block 505 of the block tree 500.

At 1008, a block bundle may be loaded based on the block definition. For example, the compiler 110 may load the block bundle 400, as the block bundle 400 may be indicated in the block definition received from the block tree 500 as being the block bundle from which the block tree 500 was generated.

At 1010, a block schema may be loaded from the block bundle. For example, the compiler 110 may load the schema 410 from the block bundle 400.

At 1012, if the block tree is successfully validated against the block schema, flow may proceed to 1016. Otherwise, flow may proceed to 1014. For example, the compiler 110 may attempt to validate the block tree 500 against the schema 410.

At 1014, an error may be returned. For example, the compiler 110 may have been unsuccessful in validating that block tree 500 against schema 410 and may return an error indicating that the block tree 500 failed validation.

At 1016, if the renditions are successfully validated for the block definition, flow may proceed to 1020. Otherwise, flow may proceed to 1018. For example, the compiler 110 may validate the renditions in the block tree 500 using the block definition 415.

At 1018, an error may be returned. For example, the compiler 110 may have been unsuccessful in validating the renditions in the block tree 500 using the block definition 415 and may return an error indicating that the block tree 500 failed validation.

At 1020, if there are any child blocks that have not yet been validated, flow may proceed back to 1002. Otherwise, flow may proceed to 1022. For example, the block tree 500 may have child blocks that may not have been validated yet. All child blocks in the block tree 500 may be validated recursively in the same manner as the block tree 500.

At 1022, a validated block tree may be generated. For example, the compiler 110 may generate and output the block tree 500 as a validated block tree that may be stored in the storage 170 and used with the canvas system 120.

Implementations of the presently disclosed subject matter may be implemented in and used with a variety of component and network architectures. FIG. 11 is an example computer 20 suitable for implementing implementations of the presently disclosed subject matter. As discussed in further detail herein, the computer 20 may be a single computer in a network of multiple computers. As shown in FIG. 11, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 12.

Many other devices or components (not shown) may be connected in a similar manner (e.g., document scanners, digital cameras and so on). Conversely, all of the components shown in FIG. 11 need not be present to practice the present disclosure. The components can be interconnected in different ways from that shown. The operation of a computer such as that shown in FIG. 11 is readily known in the art and is not discussed in detail in this application. Code to implement the present disclosure can be stored in computer-readable storage media such as one or more of the memory 27, fixed storage 23, removable media 25, or on a remote storage location.

FIG. 12 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving a block bundle comprising a schema definition that defines a structure and properties for a user interface component, editor configurations comprising specifications of customizations of the user interface component, renditions comprising renderer-specific implementations of the user interface component, and validation rules;
generating a structure for a block tree from the schema definition;
generating a block tree by performing transformations on the structure for the block tree using renderers of the renderer-specific implementations;
validating the block tree based on the validation rules; and
generating the user interface component from the validated block tree.

2. The computer-implemented method of claim 1, wherein generating a structure for a block tree from the schema definition further comprises:
determining a child block bundle of the block bundle; and
generating additional structure for the block tree from the child block bundle.

3. The computer-implemented method of claim 1, wherein validating the block tree based on the validation rules further comprises:
validating the block tree against the schema definition of the block bundle; and
validating the renditions against a block definition that is part of the schema definition.

4. The computer-implemented method of claim 1, wherein validating the block tree based on the validation rules further comprises recursively validating child block trees of the block tree.

5. The computer-implemented method of claim 1, wherein the block bundle and the block tree are renderer-agnostic.

6. The computer-implemented method of claim 1, wherein the schema definition further comprises indications of child block bundles.

7. The computer-implemented method of claim 1, wherein the renderer-specific implementations comprise one or more of HTML, LWC, and React implementations.

8. A computer-implemented system comprising:
one or more storage devices; and
a processor that sends receives a block bundle comprising a schema definition that defines a structure and properties for a user interface component, editor configurations comprising specifications of customizations of the user interface component, renditions comprising renderer-specific implementations of the user interface component, and validation rules,
generates a structure for a block tree from the schema definition,
generates a block tree by performing transformations on the structure for the block tree using renderers of the renderer-specific implementations,
validates the block tree based on the validation rules, and
generates the user interface component from the validated block tree 9. The computer-implemented system of claim 8, wherein the processor generates the structure for the block tree from the schema definition by:
determining a child block bundle of the block bundle; and
generating additional structure for the block tree from the child block bundle.

10. The computer-implemented system of claim 8, wherein the processor validates the block tree based on the validation rules by:
validating the block tree against the schema definition of the block bundle; and
validating the renditions against a block definition that is part of the schema definition.

11. The computer-implemented system of claim 8, wherein the processor validates the block tree based on the validation rules further by recursively validating child block trees of the block tree.

12. The computer-implemented system of claim 8, wherein the block bundle and the block tree are renderer-agnostic.

13. The computer-implemented system of claim 8, wherein the schema definition further comprises indications of child block bundles.

14. The computer-implemented system of claim 8, wherein the renderer-specific implementations comprise one or more of HTML, LWC, and React implementations.

15. A system comprising: one or more computers and one or more non-transitory storage devices storing instructions which are operable, when executed by the one or more computers, to cause the one or more computers to perform operations comprising:
receiving a block bundle comprising a schema definition that defines a structure and properties for a user interface component, editor configurations comprising specifications of customizations of the user interface component, renditions comprising renderer-specific implementations of the user interface component, and validation rules;
generating a structure for a block tree from the schema definition;
generating a block tree by performing transformations on the structure for the block tree using renderers of the renderer-specific implementations;
validating the block tree based on the validation rules; and
generating the user interface component from the validated block tree.

16. The system of claim 15, wherein the instructions which are operable, when executed by the one or more computers, to cause the one or more computers to perform operations comprising generating a structure for a block tree from the schema definition further cause the one or more computers to perform operations comprising:
determining a child block bundle of the block bundle; and
generating additional structure for the block tree from the child block bundle.

17. The system of claim 15, wherein the instructions which are operable, when executed by the one or more computers, to cause the one or more computers to perform operations comprising validating the block tree based on the validation rules further cause the one or more computers to perform operations comprising:
validating the block tree against the schema definition of the block bundle; and
validating the renditions against a block definition that is part of the schema definition.

18. The system of claim 15, wherein the instructions which are operable, when executed by the one or more computers, to cause the one or more computers to perform operations comprising validating the block tree based on the validation rules further cause the one or more computers to perform operations comprising recursively validating child block trees of the block tree.

19. The system of claim 15, wherein the block bundle and the block tree are renderer-agnostic.

20. The system of claim 15, wherein the schema definition further comprises indications of child block bundles.
